(19) United States
(12) Patent Application Publication
(10) Pub. No.: US 2005/0247422 A1
(43) Pub. Date: Nov. 10, 2005

(54) Parts of an air cleaner for automobiles and a method of manufacturing the same

(76) Inventor: Jung Man Kim, Seoul (KR)

Correspondence Address: White Redway & Brown, 1217 King Street, Alexandria, VA, 22314, US

(21) Appl. No.: 10/525,744

(22) PCT Filed: Sep. 1, 2003
(86) PCT No.: PCT/KR03/01782

§ 371 Date: Feb. 28, 2005

(30) Foreign Application Priority Data
Aug. 31, 2002 (KR) 10-2002-0052298

(51) Int. Cl. D21J 3/00; D21J 1/08; D21H 17/74; D21H 17/03; B60H 3/06

(52) U.S. Cl. 162/218; 162/224; 162/221; 162/168.3; 162/172

(57) ABSTRACT

The present invention relates to parts of an air cleaner for automobiles such as fixing caps and porous nets made of recycled waste paper and a method of manufacturing the same, which are more economical and environmentally friendly than those for conventional air cleaners made of metal, plastic and urethane. The parts of an air cleaner according to the present invention are obtained by dipping and homogenizing waste paper in a caustic soda aqueous solution, adding to the solution 20-25 parts by weight of paraffin wax, 5-10 parts by weight of acrylamide, 3-5 parts by weight of colloidal silica, and 15-20 parts by weight of polyvinyl alcohol, and mixing, forming, compressing and drying the solution.

### FIELD OF THE INVENTION

The present invention relates to parts of an air cleaner for automobiles and a method of manufacturing the same, and more particularly to parts of an air cleaner such as fixing caps and porous nets made of recycled waste paper and a method of manufacturing the same, which are more economical and environmentally friendly than those for conventional air cleaners made of metal, plastic and urethane.

### BACKGROUND OF THE INVENTION

To an automobile, fuel must be supplied as a power source. In order for the supplied fuel to function efficiently, air must be supplied to the automobile for the combustion of the fuel. The amount of the air inhaled by the engine of the automobile, for example the air inhaled by the engine of a passenger car is about 5,000 to 10,000 λ per 1 λ of gasoline. If dust and other impurities contained in the air are not removed before the supply of the air to the engine, however, they can damage a cylinder of the engine or accelerate the abrasion of the engine, thus shortening the life of the engine. Therefore, it is required that an air cleaner be provided in a housing as a filtering apparatus to filter out various kinds of impurities. Through the air cleaner mounted in the housing, the dust is filtered and the air is purified and supplied to a combustion chamber. Sometimes, the air cleaner can be clogged with the impurities filtered therethrough. Thus, if the air cleaner is not cleaned or replaced regularly with another one, the impurities accumulated on the air cleaner can block the supply of the air to the engine, and accordingly the output of power of the automobile can be reduced, while the consumption of fuel increases.

Conventionally, shape of air cleaners differs according to a type of automobiles. As for trucks and omnibuses, the air cleaner was formed in the shape of a cylinder. Such a cylindrical air cleaner comprises a cylindrical external net, a cylindrical internal net made of iron, a filter paper longitudinally corrugated to be provided between the external net and the internal net, and caps provided at top and bottom parts of the air cleaner to fix and maintain the external and internal nets at a predetermined interval, each of the caps including a ring-shaped rim and an iron plate.

Further, the air cleaner was shaped in the form of a hexahedron with rectangular surfaces. The hexahedral air cleaner comprises a bottom plate made of plastic or urethane and a corrugated filter paper provided above the bottom plate, or comprises the corrugated filter paper and an iron porous net provided on either side of the filter paper.

However, since such conventional air cleaners used iron as material of the components thereof, they were heavy and the manufacturing costs were high. Also, it was difficult to recycle them after use, and thus they could cause a secondary pollution. As for the air cleaners made from plastic or urethane, it took about 30 to 40 years for them to decompose after being buried, and the incineration of them generated bad smell and poisonous gas, thus causing enormous damage to the environment.

Accordingly, many advanced foreign countries require that parts of automobiles imported thereto should be made from environmentally friendly material.

The inventor of the present invention has studied to develop parts of an automobile, which are made from environmentally friendly material and superior to those made from plastic or urethane. By using recycled waste paper as material of the components of an air cleaner for an automobile such as caps and porous nets, he completed the present invention.

In the meantime, the inventor of the present invention has been interested in the development of recycled products such as panels for use as interior building material by using waste resources, which are economical, light, stable in thermal deformation, and excellent in thermal plasticity.

As an example, the inventor disclosed a method of manufacturing panels for use as interior building material in Korean Patent Application No. 95-20835, wherein the method comprises the steps of adding a mixture of 50% by weight of waste pulp, 20% of polyester fiber and 30% of polypropylene fiber to water to become an aqueous solution at the concentration of 20-30 g/λ; distributing the aqueous solution to a net-shaped belt to form a panel; passing the panel through a pair of engaging rollers to squeeze water; drying the panel at a temperature lower than the melting point of polypropylene to have the moisture content of 20% or less; dipping the dried panel in a moisture-increasing solution and pressing it through a pair of engaging rollers; and passing the panel through a drying drum at a temperature of 180˜200° C.

Further, the inventor developed another method of manufacturing panels for use as interior building material and disclosed it in Korean Patent No. 178461 dated Nov. 23, 1998.

In addition, the inventor developed a panel for use as interior building material which had been unexpectable from the above patent applications and which was excellent in fire retardancy, tolerance to weather and moisture and sound insulation and a method of manufacturing the same, as disclosed in Korean Patent Application No. 99-19464, wherein the method comprises the steps of cutting finely 70˜85% of waste pulp and 15˜30% of waste cotton and pulverizing them with a pulverizer; dissolving 5˜10 parts by weight of antimonial trioxide in an aqueous solution made by adding 5˜10 parts by weight of water to a 10˜20% acetic acid; mixing the solution with 10˜15 parts by weight of white carbon, 3˜7 parts by weight of ultrafine particulate anhydrous silica, 10˜15 parts by weight of an ethylene vinyl acetate resin emulsion and 800˜850 parts by weight of water, and then maturing the mixture solution; adding the said pulverized mixture to the mixture solution and mixing them together; pressing and drying the mixture; penetrating damp proof resin to the mixture; and secondly pressing and drying the mixture.

Furthermore, besides the panel for building purposes, the inventor also developed a method of manufacturing various formed products from pulp, which can be used at home and industrial sites, as disclosed in Korean Patent Application No. 2000-77740 entitled “a method of manufacturing dry-type pulp formed products and pulp formed products”.

### SUMMARY OF THE INVENTION

The object of the present invention is to provide parts of an air cleaner for automobiles such as fixing caps and porous nets made of recycled waste paper and a method of manufacturing the same, thus nursing resources and reducing waste of foreign currency. According to the present invention, parts of an air cleaner having an excellent quality can be manufactured at moderate costs, that is, at about 40 to 50% of the costs for manufacturing conventional parts of the air cleaner.

Another object of the present invention is to provide fixing caps and porous nets for an air cleaner and a method of manufacturing the same, without the problem of secondary pollution, generation of paper sludge, occurring in a conventional wet process.

A further object of the present invention is to provide a method of manufacturing parts of an air cleaner by using waste paper as it is, without the process of pulverizing the waste paper, which was necessary in the inventor's prior patent application, and thus rendering the present method simpler and more economical than the conventional method.

A further object of the present invention is to provide fixing caps and porous nets for an air cleaner and a method of manufacturing the same by recycling waste paper causing no environmental pollution due to its biodegradability, by which the environment can be compatible with the functionality.

A further object of the present invention is to provide environmentally friendly parts of an air cleaner and its manufacturing method, overcoming the disadvantages of the conventional method wherein endocrine disrupting chemicals such as dioxine, which are also called “environmental hormones” and harmful to the human body, were released by using waste polyester fiber and polypropylene.

In order to achieve the above objects, a method of manufacturing parts of an air cleaner according to the present invention comprises the steps of:
dipping 120-180 parts by weight of waste paper into 350-500 parts by weight of water and adding 5-10 parts by weight of caustic soda thereto to swell and homogenize the waste paper solution; adding to the waste paper solution 20-25 parts by weight of paraffin wax, 5-10 parts by weight of acrylamide, 3-5 parts by weight of colloidal silica, 15-20 parts by weight of polyvinyl alcohol, and preferably 5-10 parts by weight of dye and mixing them by stirring;
transferring the waste paper solution mixture to a tank; dipping forming molds into the tank so that the waste paper solution mixture can soak the molds; and
compressing and drying the waste paper solution mixture.

The parts of an air cleaner such as fixing caps and porous nets according to the present invention are those obtained by the above manufacturing method.

Waste paper used in the present invention can be waste newspapers, magazines, papers and boxes which have been dumped from offices, homes, public institutions, etc. Use of the waste paper in the present invention is especially preferable in that the biodegradability of the waste paper can tremendously reduce the environmental pollution, which occurs during and after the conventional manufacturing method of the parts of an air cleaner. Detailed description of the present invention will be provided hereinafter.

1. Process of Manufacturing a Raw Material Solution:

120-180 parts by weight of waste paper (20 g per one sheet of newspaper) is dipped into 350-500 parts by weight of water and 5-10 parts by weight of caustic soda is added thereto. Then, the waste paper solution is swollen for 40-60 minutes and homogenized by stirring it for 30-50 minutes in a stirrer.

The caustic soda is added to swell the waste paper in water and to regularly disperse it. Then, the waste paper solution becomes alkaline. The caustic soda is generally used to manufacture synthetic fiber, paper, pulp, foods and pharmaceuticals, to soften water and generate hydrogen and carbon. It is not a harmful substance and causes no environmental pollution.

To the waste paper solution, 20-25 parts by weight of paraffin wax (dissolved in 30-35 parts by weight of alcohol) is added and stirred for 10-15 minutes. The paraffin wax is added to the waste paper solution to make a final product obtained damp-proof. It is generally used in the manufacture of candles, crayons, cosmetics and textiles and for polishing and water repelling. It is not a harmful substance and causes no environmental pollution.

Then, to the waste paper solution obtained, 5-10 parts by weight of acrylamide is added and stirred for 10-15 minutes. The acrylamide is added for the increase of paper strength of a final paper formed product. It is odorless and white crystalline polymer, and is widely used for treatment of sewage, soil modification, textile modification, increase of paper strength, etc. It also causes no environmental pollution.

Then, 3-5 parts by weight of colloidal silica is added to the-waste paper solution and stirred for 10-15 minutes. The colloidal silica is added to increase cohesive force among paper particles by binding them, to maintain tensile force and durability of a final paper product and to improve the robustness of a paper formed product. It is a colloidal solution of ultrafine particles of anhydrous silica and as it has strong adsorptive power and adhesive force, it is widely used as a sizing agent in the manufacture of cotton and wool textile and as a catalyst. It also causes no environmental pollution.

Then, 15-20 parts by weight of polyvinyl alcohol is added to the waste paper solution and stirred for 10-15 minutes. The polyvinyl alcohol is added for cohesive force to the waste paper solution and to form a membrane on the surface of the paper formed product, thus increasing tensile force and durability of a final paper product. It is water-soluble white powder and odorless, and is used in a wide range of manufacturing processes as it being excellent in conglutination property, penetrating property, tensile strength, oil resistance, vapor permeability, and abrasion resistance. It is not toxic and causes no environmental pollution.

Further, 5-10 parts by weight of dye is optionally added to the waste paper solution and stirred for 5-10 minutes.

In the above procedure, the paraffin wax, the acrylamide, the colloidal silica, the polyvinyl alcohol and the dye can be added all together to the waster paper solution in the stirrer. However, for the easiness of mixing process, it is preferable that the additives be added in sequence.

2. Process of Compressing the Waste Paper Solution Mixture:

The waste paper solution mixture thus obtained is transferred to the tank. Then, while slowly dissociating the waste paper solution mixture to prevent precipitation, intaglio forming molds are dipped into the tank so that the waste paper solution mixture can soak the molds for 5 to 20 seconds.

The intaglio forming mold is made of aluminum having pores of 2-5 mm and internally has a stainless steel with a net of space 0.32 H/S attached thereto.

The intaglio forming molds are then raised and compressed by embossed forming molds with the pressure of 50-60 kg f/cm² at the temperature of 100-120° C. for 2 to 10 seconds, thus strengthening binding force and tensile force of the mixture. At this time, the moisture contained in the mixture is sucked in through the pores in vacuum for 3 to 10 seconds.

Then, while raising the embossed forming molds, caps and porous nets formed in the intaglio forming molds are inspired in vacuum and transferred to a drying machine.

3. Drying Process:

The formed caps and porous nets are dried by a tunnel-type belt drying machine at the temperatures of 80-90° C. Then, manufacturing of fixing caps and porous nets according to the present invention is completed.

The conditions of time, temperature, pressure and vacuum in the above compressing and drying procedures are those obtained optimum by the inventor of the present invention through repeated experiments.

### BRIEF DESCRIPTION OF THE DRAWING

FIG. 1 is a schematic diagram showing steps of a method of manufacturing parts of an air cleaner according to the present invention.

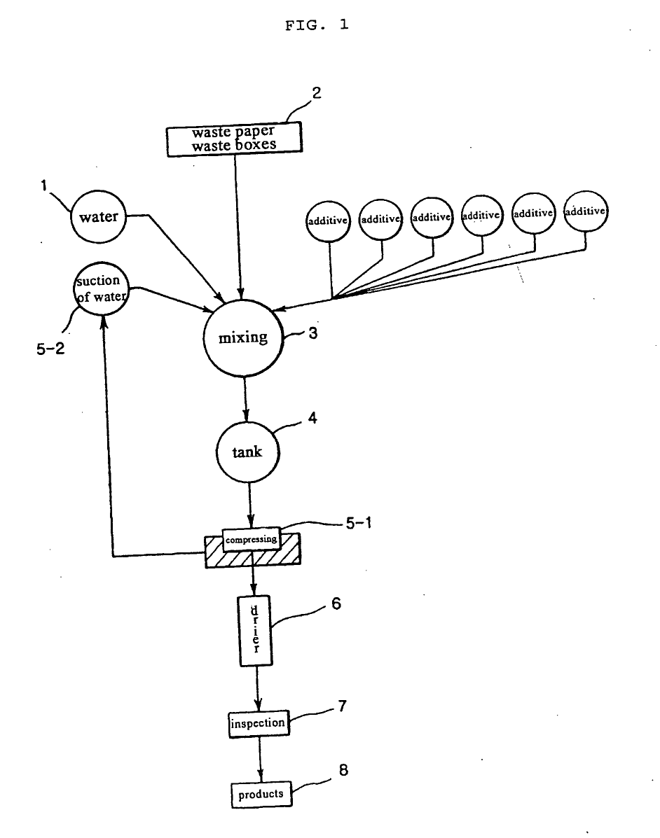

### DESCRIPTION OF THE PREFERRED EMBODIMENT

Reference will now be made in detail to a preferred embodiment of the present invention in conjunction with the accompanying drawing.

160 g of waste paper, i.e., 8 sheets of waste newspaper (20 g per one sheet of newspaper) was dipped into 500 g of water in a stirrer.

8 g of caustic soda was added as a swelling agent to the waste paper solution and the solution was swollen for about 50 minutes. Then, the waste paper solution was homogenized by stirring for 50 minutes.

To this homogenized waste paper solution, 25 g of paraffin wax, which has been dissolved in 35 g of ethanol, was added and stirred for 15 minutes.

Then, to the waste paper solution thus obtained, 10 g of acrylamide was added and stirred for 15 minutes.

Further, 5 g of colloidal silica was added to the waste paper solution and stirred for 15 minutes.

15 g of polyvinyl alcohol dissolved in 10 g of water was added in sequence to the waste paper solution and stirred for 15 minutes.

For the appearance of a final formed product, 10 g of dye was added to the waste paper solution and stirred for 10 minutes.

The waste paper solution mixture thus obtained was transferred to a tank.

In the tank, while slowly dissociating the waste paper solution mixture to prevent precipitation, intaglio forming molds for caps and porous nets were dipped into the tank so that the waste paper solution mixture could soak the forming mold for 7 seconds.

The intaglio forming molds are made of aluminum having pores of 3 mm and each of the forming molds internally has a stainless steel with a net of 0.18 thickness×space 0.32 H/S attached thereto.

The aluminum and stainless steel nets do not rust by moisture unlike the metal iron, and they are light and reduce the consumption of energy due to their high thermal conductivity.

In order to enhance the efficiency of the process, the forming molds are provided with a plurality of pores and internally have stainless steel nets attached thereto, so that the particles of the waste paper solution mixture do not outflow from the nets and the moisture contained in the solution mixture can rapidly be removed.

Then, the intaglio forming molds were raised and compressed by embossed forming molds with the pressure of 50-60 kg f/cm² at the temperature of 120° C. for 5 seconds, and the moisture contained in the mixture was sucked in through the pores in vacuum for 5 seconds.

The use of the vacuum pressure in the above process enhances the efficiency of suction in removing the moisture remaining in the solution mixture rapidly.

Then, while raising the embossed forming molds, caps and porous nets formed in the intaglio forming molds were inspired in vacuum, and being contained in a standard frame, they were transferred to a drying machine.

The formed caps and porous nets were contained in the standard frame made of aluminum while they were being transferred, so that they could be prevented from being twisted.

The transferred caps and porous nets were dried by a tunnel-type belt drying machine at the temperature of 95° C.

Then, caps and porous nets according to the present invention with the thickness of 3.5-5 mm were obtained.

The air cleaner manufactured by using the caps and the porous nets according to the present invention had the efficiency of initial cleanness 97.7%, the efficiency of life cleanness 99.2%, and the amount of piling up the dust 316.6 g, and there had been no destruction nor distortion (refer to the Experimental Data obtained from the Korean Agency for Technology and Standards: Experimental procedure KSR3029 for air cleaner filters for engines).

According to the present invention, a large quantity of caps and porous nets can be produced in a short period of time. For instance, 4 to 10 caps or porous nets can be manufactured in succession by forming the molds to cover the number of products acceptable under the standards and by dipping the molds into the waste paper solution.

As described above, the parts of the air cleaner for automobiles according to the present invention can be manufactured at moderate costs, at about 40 to 50% of the costs for manufacturing conventional parts for the air cleaner, by recycling the waste paper.

The fixing caps and porous nets according to the present invention cause no problem of secondary pollution, the generation of paper sludge, occurring in a conventional wet process.

Further, the present invention reduces the amount of industrial waste and causes no environmental pollution due to the biodegradability of the waste paper.

Furthermore, the present invention provides environmentally friendly parts of an air cleaner and its manufacturing method, overcoming the disadvantages of the conventional method wherein endocrine disrupting chemicals such as dioxine were released by using waste polyester fiber and polypropylene.

It will be apparent to those skilled in the art that various modifications and variations can be made to the present invention without departing from the spirit and scope of the invention. The present invention covers the modifications and variations thereof provided they come within the scope of the appended claims and their equivalents.

1. A method of manufacturing parts of an air cleaner for automobiles comprising the steps of:
dipping 120-180 parts by weight of waste paper into 350-500 parts by weight of water and adding 5-10 parts by weight of caustic soda thereto to swell and homogenize the waste paper solution;
adding to the waste paper solution 20-25 parts by weight of paraffin wax, 5-10 parts by weight of acrylamide, 3-5 parts by weight of colloidal silica and 15-20 parts by weight of polyvinyl alcohol, and mixing them by stirring;
transferring the waste paper solution mixture to a tank;
dipping forming molds into the tank so that the waste paper solution mixture can soak the molds; and
compressing and drying the waste paper solution mixture.

2. The method as claimed in claim 1, wherein the parts of an air cleaner are fixing caps and porous nets.

3. The method as claimed in claim 1 or claim 2, wherein 5-10 parts by weight of dye is further added to the waste paper solution.

4. The method as claimed in claim 1 or claim 2, wherein the paraffin wax, the acrylamide, the colloidal silica, and the polyvinyl alcohol are added to the waster paper solution in sequence.

5. Parts of an air cleaner for automobiles obtainable by dipping and homogenizing waste paper in a caustic soda aqueous solution, adding to the solution 20-25 parts by weight of paraffin wax, 5-10 parts by weight of acrylamide, 3-5 parts by weight of colloidal silica, and 15-20 parts by weight of polyvinyl alcohol, and mixing, forming, compressing and drying the solution.

6. The parts of an air cleaner as claimed in claim 5, wherein the parts of an air cleaner are fixing caps and porous nets.

7. The parts of an air cleaner as claimed in claim 5 or claim 6, wherein 5-10 parts by weight of dye is further added to the solution.
